(19) United States
(12) Patent Application Publication
(10) Pub. No.: US 2024/0428547 A1
(43) Pub. Date: Dec. 26, 2024

(54) MEMORY ORIENTED GAUSSIAN PROCESS BASED MULTI-OBJECT TRACKING

(71) Applicant: QUALCOMM Incorporated, San Diego, CA (US)

(72) Inventors: Rajeev Yasarla, San Diego, CA (US); Varun Ravi Kumar, San Diego, CA (US); Senthil Kumar Yogamani, Headford (IE)

(21) Appl. No.: 18/339,408

(22) Filed: Jun. 22, 2023

(51) Int. Cl. G06V 10/20; B60W 30/09; G06V 20/58

(52) U.S. Cl. CPC G06V 10/255; B60W 30/09; G06V 20/58

(57) ABSTRACT

An apparatus for multi-object tracking determines a current representation of a current object in a current image. The apparatus computes a joint Gaussian distribution between the current representation of the current object and a previous representation stored in one or more memory buffers, wherein the previous representation was determined from a previous image. The apparatus updates the one or more memory buffers based on the joint Gaussian distribution. For example, the apparatus determines whether to remove or replace the previous representation in the one or more memory buffers based on values of a covariance matrix of the joint Gaussian distribution.

### TECHNICAL FIELD

This disclosure relates to multi-object tracking, including multi-object tracking for advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include cameras, a LiDAR (Light Detection and Ranging) system, or other sensor system for sensing data indicative of the existence and location of other objects around the autonomous driving vehicle. In some examples, such an autonomous driving vehicle may be referred to as an ego vehicle. A vehicle having an ADAS is a vehicle that includes systems which may assist a driver in operating the vehicle, such as parking or driving the vehicle.

Multi-object tracking is a computer vision process that includes detecting and tracking multiple objects in a video sequence over time. One goal of multi-object tracking is to accurately track the movement of objects as they move through a scene, even as their appearance and motion may change. Multi-object tracking may be used in autonomous driving systems, including an ADAS.

### SUMMARY

The present disclosure generally relates to techniques and devices for the tracking of multiple objects across a sequence of frames of video data. Such techniques may be generally referred to as multi-object tracking. The techniques of this disclosure include the use a Gaussian process (GP) to update a memory buffer that stores representations of objects in an image.

A device may be configured to detect objects in an image using any suitable technique. The detection of the object may include generating a representation of the object, where the representation is indicative of the location of the object in the image and one or more features of the object. The device may calculate a joint Gaussian distribution between the representation of a current objected detected in a current image and one or more representations of objects stored in the memory buffer that were detected in previous images. The joint Gaussian distribution includes a mean vector and a covariance matrix. The device may compare the values of the covariance matrix to a threshold to determine if any representations currently stored in the memory buffer should be removed or replaced with a currently detected representation. The techniques of this disclosure allow for a flexible number of object representations to be stored in memory since the removal of such representations is determined based on current object detections. As such, the size of a memory buffer used to store the object representations may be kept relatively small.

In one example, this disclosure describes an apparatus for multi-object tracking, the apparatus comprising one or more memory buffers configured to store respective representations of one or more objects in an image, and one or more processors in communication with the one or more memory buffers. The one or more processors are configured to determine a current representation of a current object in a current image, compute a joint Gaussian distribution between the current representation of the current object and a previous representation stored in the one or more memory buffers, wherein the previous representation was determined from a previous image, and update the one or more memory buffers based on the joint Gaussian distribution.

In another example, this disclosure describes a method of multi-object tracking, the method comprising determining a current representation of a current object in a current image, computing a joint Gaussian distribution between the current representation of the current object and a previous representation stored in one or more memory buffers, wherein the previous representation was determined from a previous image, and updating the one or more memory buffers based on the joint Gaussian distribution.

In another example, this disclosure describes a non-transitory computer-readable storage medium storing instructions that, when executed, cause one or more processors to determine a current representation of a current object in a current image, compute a joint Gaussian distribution between the current representation of the current object and a previous representation stored in one or more memory buffers, wherein the previous representation was determined from a previous image, and update the one or more memory buffers based on the joint Gaussian distribution.

In another example, this disclosure describes an apparatus for multi-object tracking, the apparatus comprising means for determining a current representation of a current object in a current image, means for computing a joint Gaussian distribution between the current representation of the current object and a previous representation stored in one or more memory buffers, wherein the previous representation was determined from a previous image, and means for updating the one or more memory buffers based on the joint Gaussian distribution.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one to more aspects of this disclosure.

FIG. 2 is a block diagram illustrating the multi-object tracking unit of FIG. 1 in more detail.

FIG. 3 is a block diagram illustrating the Gaussian process (GP) update unit of FIG. 2 in more detail.

FIG. 4 is a flowchart illustrating one example process for multi-object tracking of the disclosure.

FIG. 5 is a flowchart illustrating another example process for multi-object tracking of the disclosure.

### DETAILED DESCRIPTION

Multi-object tracking is a computer vision process that may include the detection and tracking of multiple objects in a video sequence over time. One goal of multi-object tracking is to accurately track the movement of objects as they move through a scene, even as their appearance and motion may change. Multi-object tracking may have a wide range of applications, such as surveillance, autonomous driving, and robotics. The choice of object tracking technique may depend on the specific application requirements, the complexity of the scene, and the available resources.

Some example multi-object tracking techniques may include re-identification based methods, algorithm matching methods that match the detections of objects between frames using techniques like Kalman filtering, transformer-based tracking methods that use detections of objects in a previous frame as cross-attention, and memory-based approaches that save image crops of different objects.

Example algorithm and re-identification-based methods are not optimal for many use cases, such as autonomous driving, as such methods are very time-consuming. For example, some example re-identification-based methods compute re-identification features and detections for every frame. The term frame and image are used interchangeably. Also, the more objects that are tracked, the longer the re-identification process takes. This is because such techniques identify which identified object is the same object across multiple frames. Such a process may also use time-expensive methods, like Kalman filtering, to track the objects. Multi-object tracking in outdoor scenarios, such as autonomous driving and surveillance, may be difficult with this technique, and may require slower frame rates. Low frame rates may not be useful for autonomous driving situations where the quick detection of objects is useful for making quick and accurate driving decisions.

One issue in using the cross-attention-based multi-object tracking methods is that such methods cannot propagate an object's information over a large number of frames since they perform pair-wise cross-attention from a previous frame. In other words, cross-attention-based multi-object tracking methods compute pair-wise cross-attention between the detection from a previous frame and the encoder features detected in a current frame. Therefore, an error in a single frame will be propagated to the next frame.

Memory-based methods may extract features of objects in a current frame and use features of objects in a memory buffer to associate the detected features in the current frame in order to track the objects. Memory-based methods may include saving image crops of the detected objects in a memory buffer for a number of frames. The image crops may be image data. In addition to the image crops, memory-based methods may save a feature vector for each crop (e.g., a 128-bit feature vector).

The memory-based methods update the memory buffer with new objects but do not remove objects that may have exited the frame until a certain number of frames have passed. For example, once an object is present in a frame at time t, the memory-based methods will keep the image crop in the memory buffer for a set number of frames (e.g., until time t+T, where T is the number of frames image crops are saved). If a particular object is not present in the frame before time T has occurred, the memory-based method will store all zeroes for that image crop, as an example value that is stored, but other values may be stored.

Even though some example memory-based methods may achieve good performance, including quicker object detection at higher frame rates than some cross-attention-based multi-object tracking methods, memory-based methods typically require a large amount of memory to save object crops. As memory space is limited, and image crops are saved for a set number of frames, memory-based methods may be limited to detecting a predefined number of objects based on the memory size. A limit on the number of objects that may be detected may be very undesirable for some uses cases, such as autonomous driving. In addition, some memory-based multi-object tracking methods may be time-consuming to extract features of the save crops for every frame. As such, the multi-object tracking techniques described above are typically not scalable to frames with a large number of objects.

In view of these drawbacks, this disclosure describes memory-oriented multi-object tracking techniques that include saving multiple objects in latent representations (e.g., in a compact, memory efficient form) and using such representations to track objects across frames. Additionally, unlike previous methods, this disclosure describes memory buffer update techniques that are more efficient in terms of removing unwanted or exited objects from a frame.

More specifically, this disclosure describes a Gaussian process (GP) based memory buffer update process, which includes updating the memory buffer with representations of objects detected in the current frame in view of previously-stored representations in the memory buffer (e.g., based on when certain criteria is satisfied). A GP update unit is configured to compute a joint Gaussian distribution between an objects representation (e.g., feature vector or latent representation) and the previously-stored representations in the memory buffer. Representations of objects in the memory buffer having a high variance, as indicated by the Gaussian distribution, are removed since the representations of objects with high variance imply that they have exited the field of view and/or are no longer present in the current frame. The GP based memory update techniques of this disclosure may be used with or without latent representations of the detected objects (e.g., full representations produced by the object detection techniques may be used).

By using the latent representation and/or GP memory update techniques of this disclosure, multi-object tracking can be performed quickly, can track a large number of objects, and can use a smaller amount of memory per object tracked compared to previous techniques. As such, the multi-object tracking techniques of this disclosure are suitable for applications that would benefit from high frame rates and tracking a large number of objects, such as autonomous driving applications.

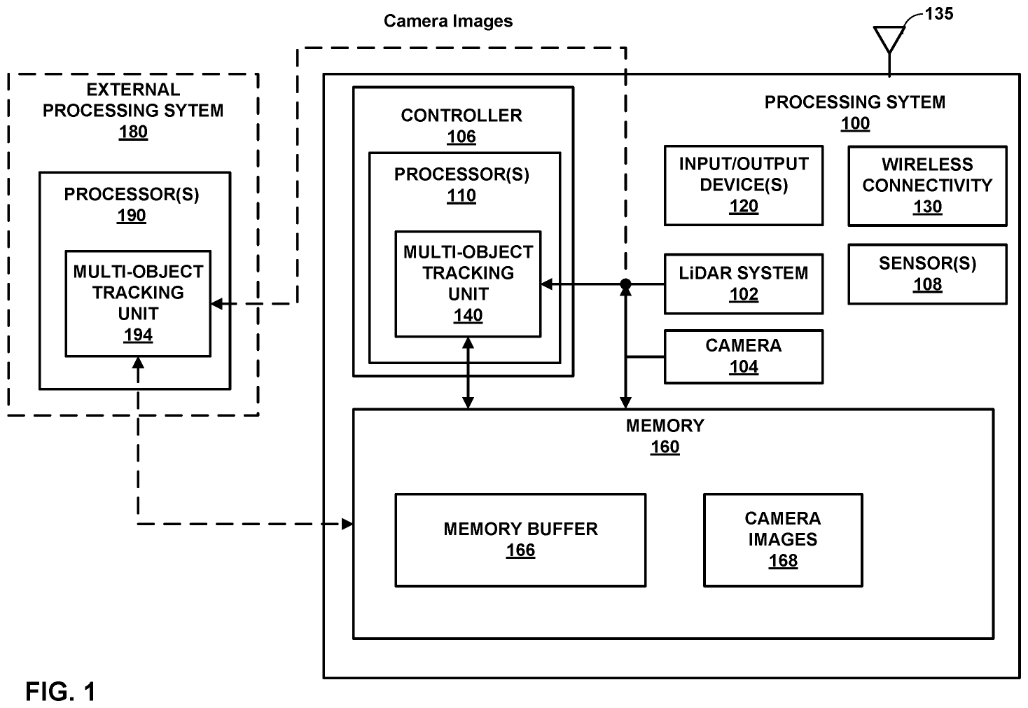

FIG. 1 is a block diagram illustrating an example processing system that may be configured to perform multi-object tracking according to one to more aspects of this disclosure. Processing system 100 may be used in a vehicle, such as an autonomous driving vehicle or an assisted driving vehicle (e.g., a vehicle having an advanced driver-assistance systems (ADAS) or an “ego vehicle”). In such an example, processing system 100 may represent an ADAS. In other examples, processing system 100 may be used in other robotic applications that may include both a camera and a LiDAR system.

Processing system 100 may include LiDAR system 102, camera 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 may emit such pulses in a 360 degree field around so as to detect objects within the 360 degree field, such as objects in front of, behind, or beside a vehicle. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 104 may be any type of camera configured to capture video or image data in the environment around processing system 100 (e.g., around a vehicle). For example, camera 104 may include a front facing camera (e.g., a front bumper camera, a front windshield camera, and/or a dashcam), a back facing camera (e.g., a backup camera), side facing cameras (e.g., cameras mounted in sideview mirrors). Camera 104 may be a color camera or a grayscale camera. In some examples, camera 104 may be a camera system including more than one camera sensor. While techniques of this disclosure for multi-object tracking will be described with reference to 2D camera images, the techniques of this disclosure may be applied to the outputs of other sensors including a LiDAR sensor, a sonar sensor, a radar sensor, an infrared camera, and/or a time-of-flight (ToF) camera, or other sensors.

Wireless connectivity component 130 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s)120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processor(s) 110.

Controller 106 may use information about objects detected in image using the techniques of this disclosure to make one or more autonomous driving decisions. Example autonomous driving decisions may be made based on object detections, such as vehicle recognition, pedestrian recognition, cyclist recognition, road sign detection, traffic light recognition, animal detection, lane marking recognition, road obstacle detection, parking space detection, weather condition recognition, and other similar detections.

For vehicle recognition, processing system 100 may detect another vehicle in its path. Controller 106 may then determine the speed, direction, and predicted path of the detected vehicle and adjusts its own speed and path to avoid collision.

For pedestrian recognition, processing system 100 may identify a pedestrian crossing or about to cross the road. Controller 106 ay automatically slow down or stop the vehicle to allow the pedestrian to cross safely.

For cyclist detection, processing system 100 may identify cyclists and predict their movements. Controller 106 may be configured to take into account the movement of the cyclist and slow down or change lanes as necessary.

For road sign detection, processing system 100 may recognize road signs such as stop signs, yield signs, speed limit signs, etc. Controller 106 may then comply with the rules indicated by these signs by slowing down or stopping when necessary.

For traffic light recognition, processing system 100 detects the color of the traffic light and controller 106 may respond appropriately. For example, if the traffic light is red, controller 106 will stop the car. If the traffic light is green, the controller 106 will cause the vehicle to go through the intersection. If the traffic light is yellow, controller 106 will prepare the car to stop (e.g., begin braking).

For animal detection, processing system 100 may identify an animal on the road and controller 106 may slow down or stop the vehicle to avoid hitting the animal.

For lane marking recognition, processing system 100 recognizes the lane markings on the road and controller 106 may control the steering of the vehicle to keep the vehicle within its own lane. If a lane change is warranted, controller 106 may determine that the neighboring lane is clear before making the move.

For road obstacle detection, processing system 100 detects road obstacles, such as debris, a broken-down vehicle, or other obstructions. In response, controller 106 may cause the vehicle to maneuver around the obstacle or stop if safe passage is not possible.

For parking space detection, processing system 100 recognizes an open parking spot and controller 106 autonomously parks the vehicle in the spot.

For weather condition recognition, through the detection of rain, snow, fog, or other adverse weather conditions, controller 106 may adapt its driving strategy for safety, such as slowing down and increasing distance with other vehicles.

Processor(s) 110 may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 110 may be loaded, for example, from memory 160 and may cause processor(s) 110 to perform the operations attributed to processor(s) in this disclosure. In some examples, one or more of processor(s) 110 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may also include one or more sensor processing units associated with LiDAR system 102, camera 104, and/or sensor(s) 108. For example, processor(s) 110 may include one or more image signal processors associated with camera 104 and/or sensor(s) 108, and/or a navigation processor associated with sensor(s) 108, which may include satellite-based positioning system components (e.g., GPS or GLONASS) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random access memory, a flash-based static memory, and the like. In this example, memory 160 includes computer-executable components, which may be executed by one or more of the aforementioned components of processing system 100.

Examples of memory 160 include random access memory (RAM), read-only memory (ROM), or a hard disk. Examples of memory 160 include solid state memory and a hard disk drive. In some examples, memory 160 is used to store computer-readable, computer-executable software including instructions that, when executed, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

Processing system 100 and/or components thereof may be configured to perform the techniques for multi-object tracking described herein. For example, processor(s) 110 may include multi-object tracking unit 140. Multi-object tracking unit 140 may be implemented in software, firmware, and/or any combination of hardware described herein. As will be described in more detail below, multi-object tracking unit 140 may be configured to receive a plurality of camera images 168 captured by camera 104. Multi-object tracking unit 140 may be configured to receive camera images 168 directly from camera 104 or from memory 160. Multi-object tracking unit 140 may detect objects in the camera images 168 and store representations of the detected objects in memory buffer 166. In some examples, memory buffer 166 may be multiple, individual memory buffers rather than a single memory buffer.

In one example of the disclosure, multi-object tracking unit 140 may be configured to determine a current representation of a current object in a current image of camera images 168. Multi-object tracking unit 140 may then compute a joint Gaussian distribution between the current representation of the current object and a previous representation stored in memory buffer 166. The previous representation was determined from a previous image of camera images 168. Multi-object tracking unit 140 may update memory buffer 166 based on the joint Gaussian distribution. As described above, the representations of detected objects stored in memory buffer 166 may be used in applications such as depth estimation, pose detection, and autonomous driving, among other applications.

The techniques of this disclosure may also be performed by external processing system 180. That is, the multi-object tracking techniques of this disclosure may be performed by a processing system that does not include the various sensors shown for processing system 100. Such a process may be referred to as an “offline” object tracking process, where the contents of memory buffer 166 are determined from images received from processing system 100. External processing system 180 may include processor(s) 190, which may be any of the types of processors described above for processor(s) 110. Processor(s) 190 may include multi-object tracking unit 194 that is configured to perform the same processes as multi-object tracking unit 140. Processor(s) 190 may acquire camera images 168 directly from camera 104, or from memory 160. Though not shown, external processing system 180 may also include a memory that may be configured to store camera images and its own memory buffer for representations of detected objects.

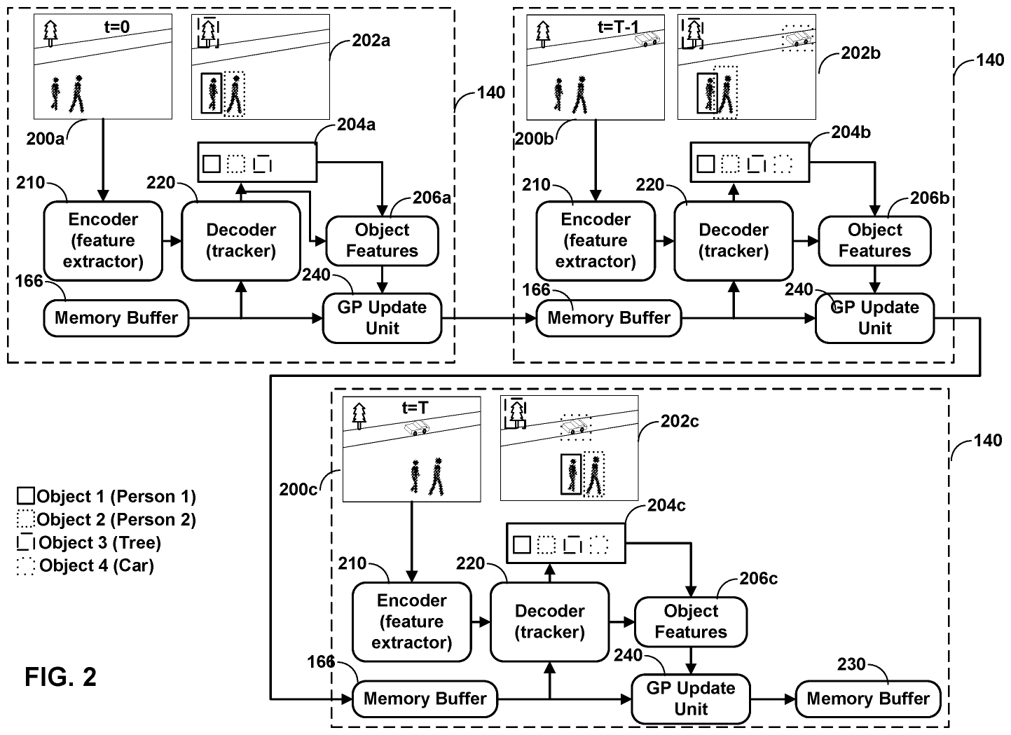

FIG. 2 is a block diagram illustrating the multi-object tracking unit 140 of FIG. 1 in more detail. FIG. 2 shows three instances of multi-object tracking unit 140. The three instances of multi-object tracking unit 140 shown in FIG. 2 are not three separate hardware units, but rather show a single instance of multi-object tracking unit 140 at a three different times operating on three different current images: current image 200a at time t=0, current image 200b at time t=T−1, and current image 200c at time t=T.

Multi-object tracking unit 140 may be configured to perform one or more techniques of this disclosure. In a general example, multi-object tracking unit 140 may be configured to store latent representations (e.g., compact versions of object features 206a, 206b, and 206c) in memory buffer 166. Additionally, multi-object tracking unit 140 may include a Gaussian process (GP) update unit 240 which updates memory buffer 166 with representations of objects detected in the current frame in view of previously-stored representations in the memory buffer.

As will be described in more detail below, GP update unit 240 is configured to compute a joint Gaussian distribution between an objects representation (e.g., feature vector or latent representation) and the previously-stored representations in memory buffer 166. Representations of objects in memory buffer 166 having a high variance, as indicated by the Gaussian distribution, compared to a threshold are removed since the representations of objects with high variance imply that such objects have exited the field of view and are no longer present in the current frame. While the techniques below will be described as being used with latent representations of objects, the GP based memory update techniques of this disclosure may be used with or without latent representations of the detected objects (e.g., full representations produced by the object detection techniques may be used).

By using the latent representation and/or GP memory update techniques of this disclosure, multi-object tracking can be performed quickly, can track a large number of objects, and can use a smaller amount of memory per object tracked compared to previous techniques. As such, the multi-object tracking techniques of this disclosure are suitable for applications that would benefit from high frame rates and tracking a large number of objects, such as autonomous driving applications.

At time t=0, multi-object tracking unit 140 may receive a current image 200a. Multi-object tracking unit 140 may use any suitable techniques to detect objects in current image 200a. Some example techniques may include the use of convolutional neural networks (CNNs), region-based CNNs (R-CNNs), fast R-CNNs, and other techniques. FIG. 2 shows an example where objects are detected in current image 200a using an encoder-decoder architecture (also called an encoder-decoder).

An encoder-decoder pair is a type of neural network architecture that may be used to detect objects within an image. Encoder-decoder architectures are typically based on a combination of CNNs and a type of recurrent neural network (RNN) known as a Long Short-Term Memory (LSTM) network. During training, the encoder-decoder pair is trained on a large dataset of labeled images. The loss function used to train the network measures the discrepancy between the predicted object detections and ground truth labels. The network may be optimized using backpropagation and stochastic gradient descent to minimize the loss. Once trained, the encoder-decoder pair can be used to detect objects within new images by passing the image through the encoder to extract features and then passing the features through the decoder to produce the object detections.

In FIG. 2, encoder 210 (also called a feature extractor) may be configured as a CNN that takes an input image (e.g., current image 200a) and processes it to extract features (e.g., a feature vector) that are relevant for object detection. The CNN may include several convolutional layers followed by pooling layers, which reduce the spatial dimensions of the feature maps, and eventually a fully connected layer that produces a fixed-length feature vector. Decoder 220 (also called a tracker) may be configured as an LSTM network that takes the feature vector produced by encoder 210 as input and produces a sequence of detection boxes 204a and corresponding object class probabilities. Decoder 220 may be configured to predict the location of objects in current image 200a and the class of each object. The class of the object may indicate the type of object (e.g., car, person, vegetation, animal, sign, road marking, etc.). The LSTM network of decoder 200 may operate on the feature vectors produced by encoder 210 sequentially, producing one output at a time. Decoder 200 uses the features stored in memory buffer 166 as query inputs, and uses the output of encoder 210 as key values. In this way, decoder 220 performs cross attention between memory buffer 166 and the current frames output from encode 210. Each output corresponds to a specific object class and its detection box 204a location within the image. Each detection box 204a represents a candidate object location in the image (e.g., current image 200a), and each object class probability represents the likelihood that the object is of a particular class.

FIG. 2 shows detected image 202a that includes the detection boxes for objects detected in current image 200a. It should be understood that detected image 202a is just explanatory, and multi-object tracking unit 140 may not actually produce detected image 202a. Detected image 202a shows three different detected objects as shown by the different dashes used for detection boxes 204a. Object 1 is a first person (Person 1), Object 2 is a second person (Person 2), and Object 3 is a tree.

Multi-object tracking unit 140 may take the feature vector produced by encoder 210, along with the locations of detection boxes 204a to form object features 206a. In some examples, multi-object tracking unit 140 may compute a latent representation of the detected objects using their corresponding detection boxes 204a and the features vector produced by encoder 210. In one example, the latent representation of the particular object is obtained by cropping out the features vector produced by encoder 210 and the corresponding detected object bounding box. For example, the input is a 256×256 image, the feature map (F_e) output from encoder 210 is 128×64×64, and the detected object's (O_i) bounding box (b_i) is (x=100, y=100, Height=60, width=30). Then F_e is resized to 128×256×256, and a latent representation of O_i is the cropped portion of F_e using b_i.

Multi-object tracking unit 140 may crop out corresponding latent features (e.g., the latent representation) for each detected object from the output of encoder 210 in order to store a representation (e.g., object features 206a) of the objects in memory buffer 166 with a smaller size. In general, object features 206a may be referred to as representations of objects detected in current image 200a, regardless of whether the feature vectors are stored as full representations or latent representations.

GP update unit 240 updates the contents of memory buffer 166 based on the current contents of memory buffer 166 as well as the detection boxes and feature vectors (latent or not) of object features 206a. Memory buffer 166 stores one or more previous representations of objects detected in prior images. Again, these representations may be full features vectors and detection boxes, or latent representations of feature vectors and detection boxes.

GP update unit 240 may determine to add a current representation of an object detected in current image 200a to memory buffer 166 if that object was not previously detected. GP update unit 240 may determine to update with a joint distribution between the current representation of an object detected in current image and a prior representation of the same object 200a if the prior representation and the current representation are of the same object. GP update unit 240 may also determine whether or not to remove any prior representations stored in memory buffer 166 if it is determined that such a prior representation is of an object that is no longer in the current image 200a. In some examples, GP update unit 240 may only remove a prior representation from memory buffer 166 if it is determined that such a representation is from an object that has not been detected in N number of consecutive image.

As will be explained in more detail below, to determine how to update memory buffer 166, GP update unit 240 may compute a joint Gaussian distribution between the representation of an object detected in current image and one or more previous representations already stored in memory buffer 166. A joint Gaussian distribution is an example a probability density function (PDF). In neural networks, PDFs may be used to model the distribution of input data or to represent the output of the network as a probability distribution over a set of possible values. PDFs provide a way to model uncertainty and variability in the data and can be used to estimate the likelihood of different outcomes.

A Gaussian distribution, also known as the normal distribution, is a common PDF used in neural networks. The Gaussian distribution is a continuous distribution that is symmetric and bell-shaped, with the probability density concentrated around the mean value. The parameters of the Gaussian distribution include the mean and standard deviation (or variance).

A joint Gaussian distribution is a multivariate probability distribution that describes the joint behavior of two or more random variables assuming that their distributions are Gaussian or normal. In the context of this disclosure, the two random variables may be a representation of an object detected in a current image and a previous representation already stored in memory buffer 166. A joint Gaussian distribution is characterized by its mean vector and covariance matrix. The mean vector contains the means of each random variable, and the covariance matrix contains the variances and covariances of the random variables.

The mean vector of a multivariate Gaussian distribution is a vector of means, where each element represents the mean value of a different random variable. In the context of the joint Gaussian distribution, the mean vector is a vector of means for all the random variables involved. For example, there are two random variables X and Y, the mean vector would be a 2-dimensional vector [μX, μY]. The mean vector is a measure of the central tendency of the distribution and indicates where the distribution is centered.

The covariance matrix of a multivariate Gaussian distribution is a square matrix that contains the variances and covariances of the random variables involved. The diagonal elements of the matrix represent the variances of each random variable, while the off-diagonal elements represent the covariances between the random variables. In the context of the joint Gaussian distribution, the covariance matrix describes the way in which the random variables are related to each other. For example, if there are two random variables X and Y, the covariance matrix would be a 2×2 matrix:

$$\vert \begin{matrix}{σ}^{2} X & ρ XY * σ X * σ Y \vert\end{matrix}$$

$$\sum = \vert$$

$$\vert \begin{matrix}ρ XY * σ X * σ Y & {σ}^{2} Y \vert ,\end{matrix}$$

where σ²X and σ²Y are the variances of X and Y, respectively, and ρXY is the correlation coefficient between X and Y. The covariance matrix is a measure of the dispersion of the distribution and indicates how the different random variables vary with respect to each other.

GP update unit 240 obtains a current representation (e.g. object features 206a) of a current object in current image 200a. In one example, the current representation of the current object includes a location of the current object (e.g., a detection box 204a) in current image 200a and a latent representation of one or more features of the current object, as described above. In some examples, the current representation includes a feature vector.

GP update unit 240 computes a joint Gaussian distribution between the current representation of the current object and a previous representation stored in memory buffer 166. Multi-object tracking unit 140 determined the previous representation from a previous image. GP update unit 240 then updates memory buffer 166 based on the joint Gaussian distribution.

As described above, the joint Gaussian distribution includes a covariance matrix. In one example, to update memory buffer 166 based on the joint Gaussian distribution, GP update unit 240 is configured to determine whether to remove or replace the previous representation in the one or more memory buffers based on values of the covariance matrix. GP update unit 240 may determine to replace the previous representation with the current representation of the current object based on the values of the covariance matrix being less than or equal to a threshold. That is, low values for the covariance matrix may indicate that the previous representation and the current representation are of the same object. In this case, GP update unit 240 may replace the prior representation with the current representation in memory buffer 166. In one example, GP update unit 240 may obtain a single value for a single object in covariance matrix, and then compare that single covariance value of the with the threshold. For example, when the ith representation in memory and jth object in current frame are same, then the (I,j) value in the covariance matrix is used and compared with the threshold.

In cases where the memory buffer 166 stores a plurality of previous representations (e.g., N number of previous representations), GP update unit 240 may be configured to determine a matching representation of the N number of previous representations, wherein the matching representation is a same object as the current object. For example, the joint distribution with the lowest covariance values, that is still below the threshold, between the current representation and the N number of previous representations is determined to be associated with the previous representation that is of the same object as the current representation. In this way, GP update unit 240 determines whether to replace the matching representation with the current representation based on the values of the covariance matrix.

If all computed joint distributions have covariance values above the threshold, GP update unit 240 may determine that the current representation is of a new object not previously stored in memory buffer 166, and may store the current representation in memory buffer 166. The process may also be used in the reverse to remove prior representations stored in memory buffer 166 based on the covariance values. GP update unit 240 may determine to remove a previous representation in memory buffer 166 based on the values of the covariance matrix being greater than the threshold. In some examples, GP update unit 240 will determine to remove the previous representation from memory buffer 166 based on the values of the covariance matrix being greater than a threshold for a number of frames. The number of frames may be a predetermined number of may be adjustable based on the size of the memory buffer. That is, rather than immediately removing a prior representation from memory buffer 166 the first time it is not observed in the current processed image, GP update unit 240 may keep the prior representation in the memory buffer until it has not been observed for a number of frames. This presents prior representation data being lost when an object is temporarily obscured or when such an object is coming in and out of the frame. In one example, GP update unit 240 may store a count value for each object, where the count value is updated whenever the covariance value (i,j) is less than the threshold. When the count value exceeds some predetermined number, GP update unit 240 may remove the object from memory buffer 166.

In some examples, GP update unit 240 may compute respective joint Gaussian distributions between the current representation of the current object and N number of previous representations stored in the one or more memory buffers. In some examples, the N number of previous representations is every previous representation stored in memory buffer 166. In another example, the N number of previous representations are from an N nearest previous representations to the current representation. GP update unit 240 may determine the N nearest previous representations to the current representation based on the locations of detection boxes 204a. Given the relatively high frame rate of cameras, it is likely that objects detected in one image will be relatively near to the same place in the next image. The number of previous representations on which a joint Gaussian distribution is computed may be adjustable based on the application.

The foregoing described one process for updating memory buffer 166 at time t=0. The process above was described with respect to a single current representation of one object. In current image 200a, there were three detected objects. As such, the process described above may be performed for representations of every detected objects in the image.

At time t=T−1, multi-object tracking unit 140 may perform the techniques of the disclosure on new current image 200b using the contents of memory buffer 166 updated at time t=0. Multi-object tracking unit 140 may determine detection boxes 204b in detected image 202b and may generate object features 206b. FIG. 2 shows detected image 202b that includes the detection boxes for objects detected in current image 200b. Detected image 202b shows four different detected objects as shown by the different dashes used for detection boxes 204b. Object 1 is a first person (Person 1), Object 2 is a second person (Person 2), Object 3 is a tree, and Object 4 is a car.

At time t=T, multi-object tracking unit 140 may perform the techniques of the disclosure on new current image 200c using the contents of memory buffer 166 updated at time t=T−1. Multi-object tracking unit 140 may determine detection boxes 204c in detected image 202c and may generate object features 206c. FIG. 2 shows detected image 202c that includes the detection boxes for objects detected in current image 200c. Detected image 202c shows four different detected objects as shown by the different dashes used for detection boxes 204b. Object 1 is a first person (Person 1), Object 2 is a second person (Person 2), Object 3 is a tree, and Object 4 is a car.

The following describes one example of the GP update process in more detail. First, denote the object detection network of multi-object tracking unit 140 as f_{θ} where θ are parameters of the network. Encoder 210 is denoted g and decoder 220 is denoted as h. Initialize memory buffer 166 (Mₜ) as M₀=0.

At every time step t, image It is passed through to encoder 210 to obtain query features Qₜ. Qₜ and Mₜ are passed through decoder 220 to obtain detection boxes ({D_{t,i}}ᵢ₌₁^{N}) (assuming N objects detected) and tracked objects. Object features O_{t,i} of the i\hat{ }th object are extracted using masking query features Qₜ with corresponding detection box D_{t,i}.

Next, the memory update step Mₜ₊₁ is described. For every object j in memory buffer 166, we first obtain “N” nearest neighbors in Object features Oₜ and formulate the joint Gaussian distribution between {O_{t,i}}ᵢ₌₁^{M} and M_{t,j} as follows:

$$( \begin{matrix}{O}_{t , 1} \\ … \\ {O}_{t , M} \\ {M}_{t , j}\end{matrix} ) = N ( ( \begin{matrix}{u}_{t , 1}^{O} \\ … \\ {μ}_{t , M}^{O} \\ {μ}_{t , j}^{M}\end{matrix} ) , [ \begin{matrix}K ( {O}_{t , 1} , {O}_{t , 1} ) & … & K ( {O}_{t , 1} , {M}_{t , j} ) \\ ⋮ & ⋱ & ⋮ \\ K ( {M}_{t , j} , {O}_{t , 1} ) & … & K ( {M}_{t , j} , {O}_{t , 1} )\end{matrix} ] )$$

Here K(.) is a kernel function. For example, K(.) can be a linear kernel, a squared exponential, a Radial basis function kernel, or any learned kernel function.

Memory buffer 166 at time t+1 (M_{t+1,j}) is computed as follows:

$${μ}_{t , j}^{M} = {K ( {M}_{t , j} , {O}_{t} ) [ K ( {O}_{t} , {O}_{t} ) + {σ}^{2} I ]}^{- 1} {O}_{t}$$

$${\sum }_{t , j}^{M} = K ( {M}_{t , j} , {M}_{t , j} ) - {K ( {M}_{t , j} , {O}_{t} ) [ K ( {O}_{t} , {O}_{t} ) + {σ}^{2} I ]}^{- 1} K ( {O}_{t} , {M}_{t , j} ) + {σ}^{2}$$

Here σ² is learned during training, and I is an identity matrix.

If Σ_{t,j}^{M}>Threshold for T time steps then object j is removed from memory buffer 166 (e.g., implying that object j is exited).

Otherwise M_{t+1,j} is updated as:

$${M}_{t + 1 , j} = ( {M}_{t , j} + {μ}_{t , j}^{M} ) / 2$$

In this way Mₜ₊₁ is passed to the next time iteration t+1 (e.g., the next frame).

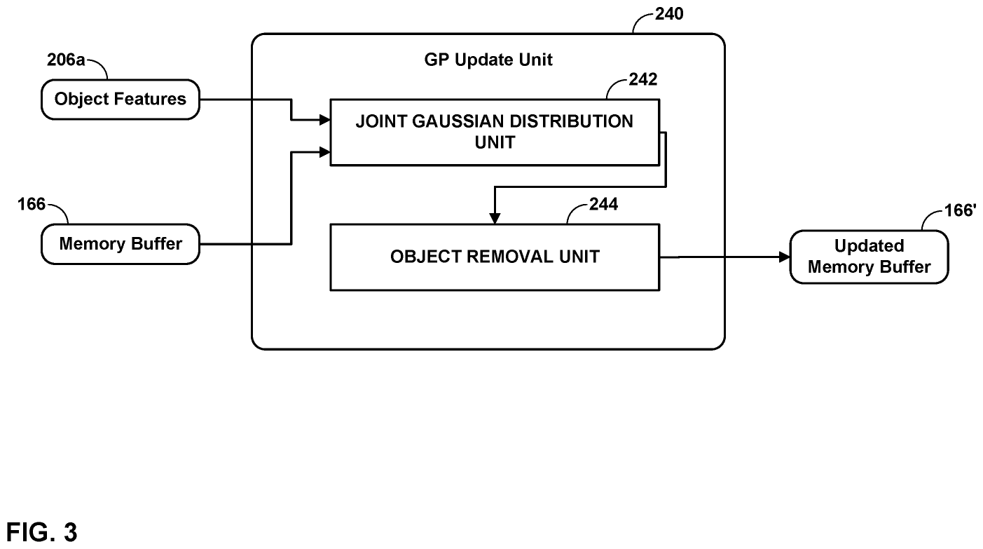

FIG. 3 is a block diagram illustrating GP update unit 240 of FIG. 2 in more detail. As show in FIG. 3, GP update unit 240 includes a joint Gaussian distribution unit 242 and an object removal unit 244. Joint Gaussian distribution unit 242 takes object features 206a and the contents of memory buffer 166 as inputs. Joint Gaussian distribution unit 242 generates a joint Gaussian distribution between a current representation of an object (e.g., from object features 206a) and a prior representation stored in memory buffer 166, as described above.

Joint Gaussian distribution unit 242 passes a covariance matrix to object removal unit 244. Object removal unit 244 compares the covariance matrix to a threshold and updated memory buffer 166 to produce updated memory buffer 166′ using any of the techniques described above.

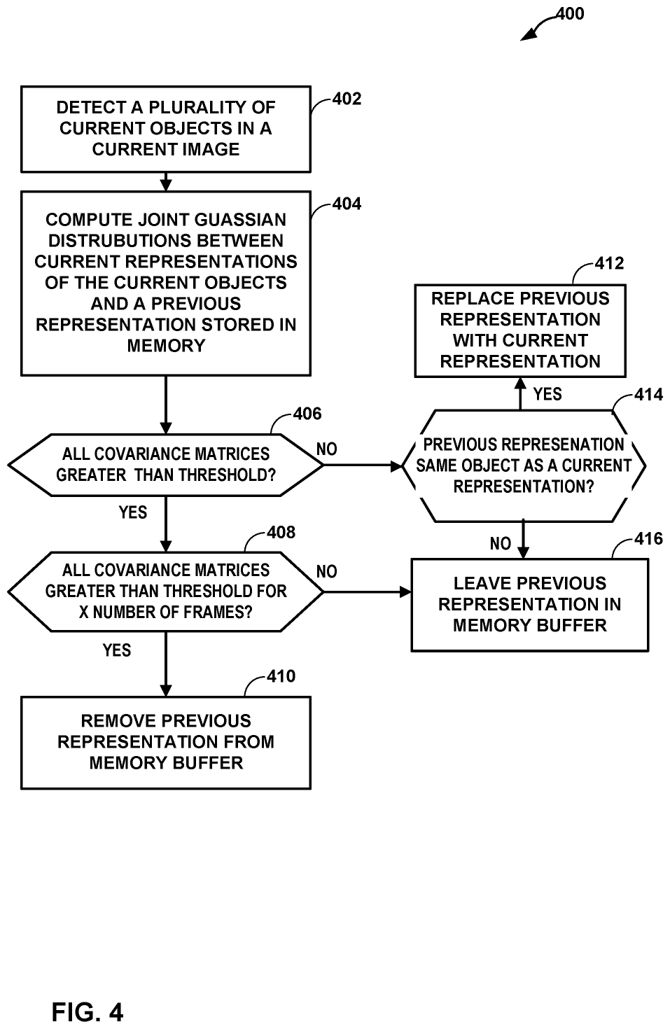

FIG. 4 is a flowchart illustrating one example process 400 for multi-object tracking of the disclosure. The techniques of FIG. 4 may be performed by one or more processors of processing system 100 or external processing system 180, including one or more processors of multi-object tracking unit 140 or multi-object tracking unit 194. That is, each of the techniques described below may be performed by any combination of processors and/or processing circuitry in any combination. It is not required that a single processor perform every step.

At 402, multi-object tracking unit 140 may detect a plurality of current objects in a current image. For example, multi-object tracking unit 140 may use the encoder-decoder architecture described above to detect objects in a current image. Multi-object tracking unit 140 may determine a representation of the objects. In one example, the representation includes a location and size of detection box as well as a latent representation of a feature vector of the detected objects.

At 404, multi-object tracking unit 140 computes joint Gaussian distributions between the current representations of the current objects detected in the image and at least one previous representation stored in a memory (e.g., memory buffer 166). At 406, multi-object tracking unit 140 determines if all covariance matrices of the joint Gaussian distributions are greater than a threshold. If no at 406, this implies may be the same object as a current representation of an object detected in the current image. At 414, multi-object tracking unit 140 determines if the previous representation is the same object as one of the current representations. If yes at 414, multi-object tracking unit 140 replaces the previous representation in the memory buffer with the current representation (412). If no at 414, multi-object tracking unit 140 leaves the previous representation in the memory buffer (416).

If yes at 406, this implies that the previous representation is no longer in the current image. If yes at 406, multi-object tracking unit 140, at 408, determines if all covariance matrices for the previous representation have been greater than the threshold for X number of frames. If no at 408, multi-object tracking unit 140 leaves the previous representation in the memory buffer (416). If yes at 408, multi-object tracking unit 140 removes the previous representation from the memory buffer (410). Process 400 may be repeated for every previous representation stored in the memory buffer, or for the N nearest previous representations to each of the current representations.

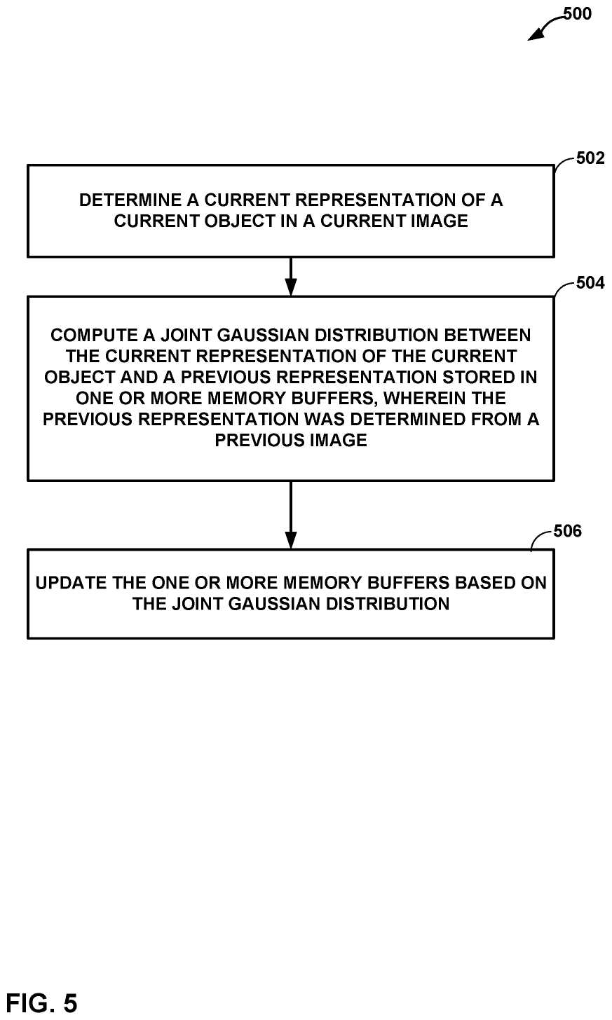

FIG. 5 is a flowchart illustrating an example process 500 for multi-object tracking of the disclosure. The techniques of FIG. 5 may be performed by one or more processors of processing system 100 or external processing system 180, including one or more processors of multi-object tracking unit 140 or multi-object tracking unit 194. That is, each of the techniques described below may be performed by any combination of processors and/or processing circuitry in any combination. It is not required that a single processor perform every step.

In one example of the disclosure, processing system 100 may be configured to determine a current representation of a current object in a current image (502). For example, processing system 100 may determine the current representation of the current object in the current image using an encoder-decoder architecture. In one example, the current representation of the current object includes a location of the current object in the current image and a latent representation of one or more features of the current object, as described above. In some examples, the current representation includes a feature vector.

Processing system 100 may be further configured to compute a joint Gaussian distribution between the current representation of the current object and a previous representation stored in the one or more memory buffers, wherein the previous representation was determined from a previous image (504), and update the one or more memory buffers based on the joint Gaussian distribution (506).

In one example, the joint Gaussian distribution includes a covariance matrix. In one example, to update the one or more memory buffers based on the joint Gaussian distribution, processing system 100 is configured to determine whether to remove or replace the previous representation in the one or more memory buffers based on values of the covariance matrix. Processing system 100 may determine to replace the previous representation with the current representation of the current object based on the values of the covariance matrix being less than or equal to a threshold. Processing system 100 may determine to remove the previous representation in the one or more memory buffers based on the values of the covariance matrix being greater than a threshold. In some examples, processing system 100 will determine to remove the previous representation in the one or more memory buffers based on the values of the covariance matrix being greater than a threshold for a number of frames. The number of frames may be a predetermined number of may be adjustable based on the size of the memory buffer.

In some examples, processing system 100 may compute respective joint Gaussian distributions between the current representation of the current object and N number of previous representations stored in the one or more memory buffers. In some examples, the N number of previous representations is every previous representation stored in the one or more memory buffers. In another example, the N number of previous representations are from an N nearest previous representations to the current representation. The number of previous representations on which a joint Gaussian distribution is computed may be adjustable based on the application.

Processing system 100 may be further configured to determine a matching representation of the N number of previous representations, wherein the matching representation is a same object as the current object. Processing system 100 may further determine whether to replace the matching representation with the current representation based on the values of the covariance matrix.

In some examples, processing system 100 may be part of an advanced driver assistance system (ADAS). In this example, processing system 100 may be configured to determine one or more autonomous driving decisions based on the respective representations of the one or more objects in the image stored in the updated one or more memory buffers. That is, autonomous driving decisions may be based on detected objects. As described above, autonomous driving decisions may be made based on object detections, such as vehicle recognition, pedestrian recognition, cyclist recognition, road sign detection, traffic light recognition, animal detection, lane marking recognition, road obstacle detection, parking space detection, weather condition recognition, and other similar detections.

Examples of the various aspects of this disclosure may be used individually or in any combination. Additional aspects of the disclosure are detailed in numbered clauses below.

Aspect 1. An apparatus for multi-object tracking, the apparatus comprising: one or more memory buffers configured to store respective representations of one or more objects in an image; and one or more processors in communication with the one or more memory buffers, the one or more processors configured to: determine a current representation of a current object in a current image; compute a joint Gaussian distribution between the current representation of the current object and a previous representation stored in the one or more memory buffers, wherein the previous representation was determined from a previous image; and update the one or more memory buffers based on the joint Gaussian distribution.

Aspect 2. The apparatus of Aspect 1, wherein the joint Gaussian distribution includes a covariance matrix, and wherein to update the one or more memory buffers based on the joint Gaussian distribution, the one or more processors are configured to: determine whether to remove or replace the previous representation in the one or more memory buffers based on values of the covariance matrix.

Aspect 3. The apparatus of Aspect 2, wherein to determine whether to remove or replace the previous representation in the one or more memory buffers based on the values of the covariance matrix, the one or more processors are configured to: determine to replace the previous representation with the current representation of the current object based on the values of the covariance matrix being less than or equal to a threshold.

Aspect 4. The apparatus of Aspect 2, wherein to determine whether to remove or replace the previous representation in the one or more memory buffers based on the values of the covariance matrix, the one or more processors are configured to: determine to remove the previous representation in the one or more memory buffers based on the values of the covariance matrix being greater than a threshold.

Aspect 5. The apparatus of Aspect 2, wherein to determine whether to remove or replace the previous representation in the one or more memory buffers based on the values of the covariance matrix, the one or more processors are configured to: determine to remove the previous representation in the one or more memory buffers based on the values of the covariance matrix being greater than a threshold for a number of frames.

Aspect 6. The apparatus of Aspect 2, wherein the one or more processors are further configured to: compute respective joint Gaussian distributions between the current representation of the current object and N number of previous representations stored in the one or more memory buffers, wherein the N number of previous representations are from an N nearest previous representations to the current representation.

Aspect 7. The apparatus of Aspect 6, wherein the one or more processors are further configured to: determine a matching representation of the N number of previous representations, wherein the matching representation is a same object as the current object.

Aspect 8. The apparatus of Aspect 7, wherein to determine whether to remove or replace the previous representation in the one or more memory buffers based on the values of the covariance matrix, the one or more processors are configured to: determine whether to replace the matching representation with the current representation based on the values of the covariance matrix.

Aspect 9. The apparatus of any of Aspects 1-8, wherein the current representation of the current object includes a location of the current object in the current image and a latent representation of one or more features of the current object.

Aspect 10. The apparatus of any of Aspects 1-9, wherein the current representation includes a feature vector.

Aspect 11. The apparatus of any of Aspects 1-10, wherein to determine the current representation of the current object in the current image, the one or more processors are configured to: determine the current representation of the current object in the current image using an encoder-decoder architecture.

Aspect 12. The apparatus of any of Aspects 1-11, wherein the one or more processors are further configured to: determine an autonomous driving decision based on the respective representations of the one or more objects in the image stored in the updated one or more memory buffers.

Aspect 13. The apparatus of Aspect 12, wherein the apparatus is part of an advanced driver assistance system (ADAS).

Aspect 14. A method of multi-object tracking, the method comprising: determining a current representation of a current object in a current image; computing a joint Gaussian distribution between the current representation of the current object and a previous representation stored in one or more memory buffers, wherein the previous representation was determined from a previous image; and updating the one or more memory buffers based on the joint Gaussian distribution.

Aspect 15. The method of Aspect 14, wherein the joint Gaussian distribution includes a covariance matrix, and wherein updating the one or more memory buffers based on the joint Gaussian distribution comprises: determining whether to remove or replace the previous representation in the one or more memory buffers based on values of the covariance matrix.

Aspect 16. The method of Aspect 15, wherein determining whether to remove or replace the previous representation in the one or more memory buffers based on the values of the covariance matrix comprises: determining to replace the previous representation with the current representation of the current object based on the values of the covariance matrix being less than or equal to a threshold.

Aspect 17. The method of Aspect 15, wherein determining whether to remove or replace the previous representation in the one or more memory buffers based on the values of the covariance matrix comprises: determining to remove the previous representation in the one or more memory buffers based on the values of the covariance matrix being greater than a threshold.

Aspect 18. The method of Aspect 15, wherein determining whether to remove or replace the previous representation in the one or more memory buffers based on the values of the covariance matrix comprises: determining to remove the previous representation in the one or more memory buffers based on the values of the covariance matrix being greater than a threshold for a number of frames.

Aspect 19. The method of Aspect 15, further comprising: computing respective joint Gaussian distributions between the current representation of the current object and N number of previous representations stored in the one or more memory buffers, wherein the N number of previous representations are from an N nearest previous representations to the current representation.

Aspect 20. The method of Aspect 19, further comprising: determining a matching representation of the N number of previous representations, wherein the matching representation is a same object as the current object.

Aspect 21. The method of Aspect 20, wherein determining whether to remove or replace the previous representation in the one or more memory buffers based on the values of the covariance matrix comprises: determining whether to replace the matching representation with the current representation based on the values of the covariance matrix.

Aspect 22. The method of any of Aspects 14-21, wherein the current representation of the current object includes a location of the current object in the current image and a latent representation of one or more features of the current object.

Aspect 23. The method of any of Aspects 14-22, wherein the current representation includes a feature vector.

Aspect 24. The method of any of Aspects 14-23, wherein determining the current representation of the current object in the current image comprises: determining the current representation of the current object in the current image using an encoder-decoder architecture.

Aspect 25. The method of any of Aspects 14-24, further comprising: determining an autonomous driving decision based on the respective representations of one or more objects stored in the updated one or more memory buffers.

Aspect 26. The method of Aspect 25, wherein the method is performed in an advanced driver assistance system (ADAS).

Aspect 27. A non-transitory computer-readable storage medium storing instructions that, when executed, cause one or more processors to: determine a current representation of a current object in a current image; compute a joint Gaussian distribution between the current representation of the current object and a previous representation stored in one or more memory buffers, wherein the previous representation was determined from a previous image; and update the one or more memory buffers based on the joint Gaussian distribution.

Aspect 28. The non-transitory computer-readable storage medium of Aspect 27, wherein the joint Gaussian distribution includes a covariance matrix, and wherein to update the one or more memory buffers based on the joint Gaussian distribution, the instructions further cause the one or more processors to: determine whether to remove or replace the previous representation in the one or more memory buffers based on values of the covariance matrix.

Aspect 29. An apparatus for multi-object tracking, the apparatus comprising: means for determining a current representation of a current object in a current image; means for computing a joint Gaussian distribution between the current representation of the current object and a previous representation stored in one or more memory buffers, wherein the previous representation was determined from a previous image; and means for updating the one or more memory buffers based on the joint Gaussian distribution.

Aspect 30. The apparatus of Aspect 29, wherein the joint Gaussian distribution includes a covariance matrix, and wherein the means for updating the one or more memory buffers based on the joint Gaussian distribution comprises: means for determining whether to remove or replace the previous representation in the one or more memory buffers based on values of the covariance matrix.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for multi-object tracking, the apparatus comprising:
one or more memory buffers configured to store respective representations of one or more objects in an image; and
one or more processors in communication with the one or more memory buffers, the one or more processors configured to:
determine a current representation of a current object in a current image;
compute a joint Gaussian distribution between the current representation of the current object and a previous representation stored in the one or more memory buffers, wherein the previous representation was determined from a previous image; and
update the one or more memory buffers based on the joint Gaussian distribution.

2. The apparatus of claim 1, wherein the joint Gaussian distribution includes a covariance matrix, and wherein to update the one or more memory buffers based on the joint Gaussian distribution, the one or more processors are configured to:
determine whether to remove or replace the previous representation in the one or more memory buffers based on values of the covariance matrix.

3. The apparatus of claim 2, wherein to determine whether to remove or replace the previous representation in the one or more memory buffers based on the values of the covariance matrix, the one or more processors are configured to:
determine to replace the previous representation with the current representation of the current object based on the values of the covariance matrix being less than or equal to a threshold.

4. The apparatus of claim 2, wherein to determine whether to remove or replace the previous representation in the one or more memory buffers based on the values of the covariance matrix, the one or more processors are configured to:
determine to remove the previous representation in the one or more memory buffers based on the values of the covariance matrix being greater than a threshold.

5. The apparatus of claim 2, wherein to determine whether to remove or replace the previous representation in the one or more memory buffers based on the values of the covariance matrix, the one or more processors are configured to:
determine to remove the previous representation in the one or more memory buffers based on the values of the covariance matrix being greater than a threshold for a number of frames.

6. The apparatus of claim 2, wherein the one or more processors are further configured to:
compute respective joint Gaussian distributions between the current representation of the current object and N number of previous representations stored in the one or more memory buffers, wherein the N number of previous representations are from an N nearest previous representations to the current representation.

7. The apparatus of claim 6, wherein the one or more processors are further configured to:
determine a matching representation of the N number of previous representations, wherein the matching representation is a same object as the current object.

8. The apparatus of claim 7, wherein to determine whether to remove or replace the previous representation in the one or more memory buffers based on the values of the covariance matrix, the one or more processors are configured to:
determine whether to replace the matching representation with the current representation based on the values of the covariance matrix.

9. The apparatus of claim 1, wherein the current representation of the current object includes a location of the current object in the current image and a latent representation of one or more features of the current object.

10. The apparatus of claim 1, wherein the current representation includes a feature vector.

11. The apparatus of claim 1, wherein to determine the current representation of the current object in the current image, the one or more processors are configured to:
determine the current representation of the current object in the current image using an encoder-decoder architecture.

12. The apparatus of claim 1, wherein the one or more processors are further configured to:
determine an autonomous driving decision based on the respective representations of the one or more objects in the image stored in the updated one or more memory buffers.

13. The apparatus of claim 12, wherein the apparatus is part of an advanced driver assistance system (ADAS).

14. A method of multi-object tracking, the method comprising:
determining a current representation of a current object in a current image;
computing a joint Gaussian distribution between the current representation of the current object and a previous representation stored in one or more memory buffers, wherein the previous representation was determined from a previous image; and
updating the one or more memory buffers based on the joint Gaussian distribution.

15. The method of claim 14, wherein the joint Gaussian distribution includes a covariance matrix, and wherein updating the one or more memory buffers based on the joint Gaussian distribution comprises:
determining whether to remove or replace the previous representation in the one or more memory buffers based on values of the covariance matrix.

16. The method of claim 15, wherein determining whether to remove or replace the previous representation in the one or more memory buffers based on the values of the covariance matrix comprises:
determining to replace the previous representation with the current representation of the current object based on the values of the covariance matrix being less than or equal to a threshold.

17. The method of claim 15, wherein determining whether to remove or replace the previous representation in the one or more memory buffers based on the values of the covariance matrix comprises:
determining to remove the previous representation in the one or more memory buffers based on the values of the covariance matrix being greater than a threshold.

18. The method of claim 15, wherein determining whether to remove or replace the previous representation in the one or more memory buffers based on the values of the covariance matrix comprises:
determining to remove the previous representation in the one or more memory buffers based on the values of the covariance matrix being greater than a threshold for a number of frames.

19. The method of claim 15, further comprising:
computing respective joint Gaussian distributions between the current representation of the current object and N number of previous representations stored in the one or more memory buffers, wherein the N number of previous representations are from an N nearest previous representations to the current representation.

20. The method of claim 19, further comprising:
determining a matching representation of the N number of previous representations, wherein the matching representation is a same object as the current object.

21. The method of claim 20, wherein determining whether to remove or replace the previous representation in the one or more memory buffers based on the values of the covariance matrix comprises:
determining whether to replace the matching representation with the current representation based on the values of the covariance matrix.

22. The method of claim 14, wherein the current representation of the current object includes a location of the current object in the current image and a latent representation of one or more features of the current object.

23. The method of claim 14, wherein the current representation includes a feature vector.

24. The method of claim 14, wherein determining the current representation of the current object in the current image comprises:
determining the current representation of the current object in the current image using an encoder-decoder architecture.

25. The method of claim 14, further comprising:
determining an autonomous driving decision based on the respective representations of one or more objects stored in the updated one or more memory buffers.

26. The method of claim 25, wherein the method is performed in an advanced driver assistance system (ADAS).

27. A non-transitory computer-readable storage medium storing instructions that, when executed, cause one or more processors to:
determine a current representation of a current object in a current image;
compute a joint Gaussian distribution between the current representation of the current object and a previous representation stored in one or more memory buffers, wherein the previous representation was determined from a previous image; and
update the one or more memory buffers based on the joint Gaussian distribution.

28. The non-transitory computer-readable storage medium of claim 27, wherein the joint Gaussian distribution includes a covariance matrix, and wherein to update the one or more memory buffers based on the joint Gaussian distribution, the instructions further cause the one or more processors to:
determine whether to remove or replace the previous representation in the one or more memory buffers based on values of the covariance matrix.

29. An apparatus for multi-object tracking, the apparatus comprising:
means for determining a current representation of a current object in a current image;
means for computing a joint Gaussian distribution between the current representation of the current object and a previous representation stored in one or more memory buffers, wherein the previous representation was determined from a previous image; and
means for updating the one or more memory buffers based on the joint Gaussian distribution.

30. The apparatus of claim 29, wherein the joint Gaussian distribution includes a covariance matrix, and wherein the means for updating the one or more memory buffers based on the joint Gaussian distribution comprises:
means for determining whether to remove or replace the previous representation in the one or more memory buffers based on values of the covariance matrix.
